(19) United States
(12) Patent Application Publication
(10) Pub. No.: US 2017/0253078 A1
(43) Pub. Date: Sep. 7, 2017

(54) LIGHTWEIGHT PROCESS OF MANUFACTURING BICYCLE'S RIMS AND RIM STRUCTURE MANUFACTURED THEREBY

(71) Applicant: ALEX GLOBAL TECHNOLOGY, INC., TAINAN CITY (TW)

(72) Inventor: WEI-CHIN CHEN, TAINAN CITY (TW)

(21) Appl. No.: 15/057,244

(22) Filed: Mar. 1, 2016

(51) Int. Cl. B60B 25/22; B60B 21/02; B60B 21/06; B60B 1/00; B60B 1/04

(52) U.S. Cl. CPC B60B 25/22; B60B 1/003; B60B 1/041; B60B 21/062; B60B 21/025; B60B 1/006; B60C 29/02

(57) ABSTRACT

This invention is related to a lightweight process of manufacturing a bicycle's rim and a rim structure manufactured thereby. A rim frame comprising an inner frame, a cladding part, and a support part between the inner frame and the cladding part. The inner frame and the support part are milled to form plural through holes uniformly distributed thereon. The areas occupied by the through holes is 35% to 85% of a total surface of the inner frame and the support part. Moreover, a proper distance is formed between the adjacent through holes in the process, and a carbon fiber layer covers the outer surface of the rim frame. Therefore, the weight of the bicycle's rim is decreased, and the carbon fiber layer can stably attach on the rim frame to increase the structural strength of the rim.

### BACKGROUND

Field of Invention

The disclosure relates to a lightweight process of manufacturing a bicycle's rim and a rim structure manufactured thereby. More particularly, a lightweight process of manufacturing a bicycle's rim and a rim structure manufactured thereby is provided in this disclosure to meet the lightweight requirement and maintain the structural strength. Therefore, the practical effect of the bicycle's rim can be further increased.

Description of Related Art

Bicycles are a very convenient means for transportation. Feet's pedaling force is used to move the bicycle forward. Hence, riding bicycles not only has the effect of fitness, but also bicycles are a very good tools used for sports and leisure. Since no additional fuels are needed, riding bicycles can save energy cost and have the environmental protecting effect. In addition to the lower speed of bicycles, riding bicycles is safer.

In addition to be a basic means of transportation, bicycles also have composite functions of recreation and sports. After the elevation of research and development ability and the progress of technology, the appearance, ride comfort, body strength, weight, and speed of bicycle all become development focus. Especially for professional athletics racing bike, ride comfort, body strength, weight, and speed are absolutely the goals of the riders. In order to develop the bicycle toward the direction of lightweight construction, wheels made of carbon fibers have replaced the traditional metal wheels to effectively reduce the total weight of bicycles.

Traditional molding technology of carbon fiber rims is setting up an annular pocket and filling air into the annular pocket to inflate the annular pocket first, and then multi layers of carbon fiber cloth sequentially cover the annular pocket, wherein the number of the layers of the carbon fiber cloth is determined by the structural strength. Usually, the surface set up by spokes needs higher to structure strength, and thus 7 layers of carbon fiber cloth need to be covered thereon. The needed structure strength of the other parts of the wheels is lower, and thus 5 layers of carbon fiber cloth need to be covered thereon. However, since manufacturing the traditional carbon fiber rims needs sequentially covering multi layers of carbon fiber cloth, the manufacturing construction is quite is time-consuming and labor-consuming. In addition, it also has to be noticed that whether air is remained between the layers of the carbon fiber cloth. If air is remained, the layers of the carbon fiber cloth cannot be completely and smoothly laminated, and defective items with local protruding is thus produced. Therefore, the traditional manufacturing method cannot effectively decrease the defective rate of the carbon fiber rims. Moreover, the price of the carbon fiber cloth is expensive, and the cost of laminating multi layers of carbon fiber cloth is thus increased. The reasons above all make the price of the carbon fiber cloth wheels not close to the people.

Since manufacturing the traditional carbon fiber rims has the drawbacks described above, the inventors have developed a method of manufacturing carbon fiber rims disclosed in Taiwan Pat. Pub. No. 201538355, the method comprises the following steps.

A. A metal strip is formed to have a needed shape by heating a metal substrate to a plastic temperature and then extruding. The metal strip s comprises two side walls, a connecting wall connecting opposite terminal surfaces of the side walls, and an inner rim wall connecting the radial inner edges of the side walls to form a space surrounded by the side walls, the connecting wall, and the inner rim wall.

B. Two terminals of the strip are connected to form a circle as a rim to frame's embryo.

C. Through holes and spoke coupling holes are formed by milling the rim frame's embryo to form a rim frame. The spoke coupling holes was formed on the inner rim wall and at positions not corresponding to any through holes but disposed between the through hole. Spoke coupling elements are disposed in is the spoke coupling holes.

D. A surface roughening treatment on the rim frame having the through holes and the spoke coupling holes thereon is performed to increase roughness of the rim frame's surface;

E. A carbon fiber cloth is trimmed to have a suitable shape and then covers on the rim frame and the through holes.

F. The rim frame covered by the trimmed carbon fiber cloth in a model is heatset to form a carbon fiber layer and thus form a semi-finished carbon fiber rim.

G. A surface of the semi-finished carbon fiber rim is treated to form a finishing carbon fiber rim of a bicycle.

Although the carbon fiber rims have good structural strength and cost decreasing effect, but the through holes occupy a large area to cause poor adhesion of the carbon fiber cloth. At present, the inventors develop this lightweight process of manufacturing a bicycle's rim and a rim structure manufactured thereby by the many-year manufacturing and design experience and knowledge in the related fields and ingenuity to achieve better practical value.

### SUMMARY

A main aspect of this invention is to provide a lightweight process of manufacturing a bicycle's rim and a rim structure manufactured thereby. Especially, a lightweight process of manufacturing a bicycle's rim and a rim structure manufactured thereby is provided to meet the lightweight requirement and maintain the structural strength. Therefore, the practical effect of the bicycle's rim can be further increased.

The main purposes and the effects of the lightweight process of a bicycle's rim in this invention are reached by the following specific technical means. The steps are described below.

S1) A rim frame comprising an inner frame, a cladding part, and a support part between the inner frame and the coating part is provided. The inner frame comprises several spoke coupling holes disposed circularly and a gas nozzle hole penetrating the inner frame part and the support part.

S2) The inner frame and the support part are milled to form plural through holes uniformly distributed thereon. The areas occupied by the through holes is 35% to 85% of the total surface of the inner frame and the support part, as well as a distance between the adjacent through holes is 0.5-1.5 mm.

S3) The surface of the rim frame is roughened to increase the roughness thereof.

S4) A carbon fiber cloth is trimmed to a predetermined shape and then the rim frame and the through holes are covered by the trimmed carbon fiber cloth.

S5) The rim frame covered by the trimmed carbon fiber cloth in a mold is heatset to form a carbon fiber layer.

S6) The surface of the rim frame covered by the carbon fiber layer is treated to obtain a lightweight rim product of a bicycle.

In a preferred embodiment of the described lightweight process of a bicycle's rim, the rim frame is made from an aluminum alloy or a magnesium alloy.

In a preferred embodiment of the described lightweight process of a bicycle's rim, the surface treating step comprises polishing the surface and then spraying to form a protective layer thereon.

In a preferred embodiment of the described lightweight process of a bicycle's rim, the rim frame is covered by 1-2 layers of the carbon fiber cloth, and striations of the carbon fiber cloth are staggeringly laminated.

The main purposes and the effects of the bicycle's lightweight rim in this invention are reached by the following specific technical means. The rim comprises a rim frame comprising an inner frame combined with spokes, a cladding part corresponding to an assembled tire, and a support part between the inner frame and the cladding part. Plural spoke coupling holes are circularly disposed on the inner frame. A gas nozzle hole penetrates the inner frame. Plural through holes are distributed on the inner frame and the support part, wherein area occupied by the through holes is 35% to 85% of the total surface of the inner frame and the support part, and a distance between the adjacent through holes is kept at 0.5-1.5 mm. A carbon fiber layer covers the rim frame made from at least a layer of carbon fiber cloth having holes corresponding to the spoke coupling holes and the gas nozzle hole but covering the through holes. Therefore, the weight of the bicycle's rim is decreased, and the carbon fiber layer can stably attach on the rim frame to increase the structural strength of the rim.

### BRIEF DESCRIPTION OF THE DRAWINGS

FIG. 1 is a process flow diagram of this invention.

FIG. 2 is an appearance diagram of a rim frame of this invention.

FIG. 3 is an appearance diagram of the rim frame having the milled through holes of this invention.

FIG. 4 is an appearance diagram of the rim frame covered by a carbon fiber cloth of this invention.

FIG. 5 is an appearance diagram of a lightweight rim of this invention.

FIG. 6 is a cross-sectional diagram of a lightweight rim of this invention.

### DETAILED DESCRIPTION

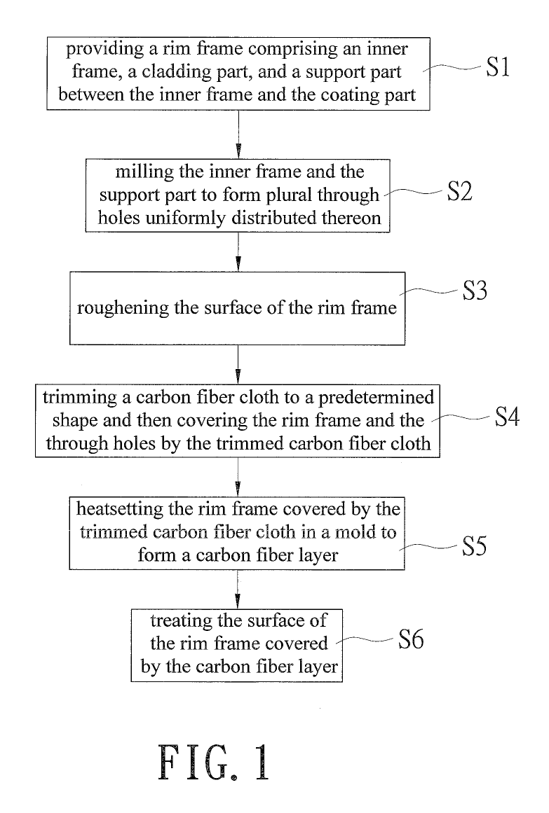

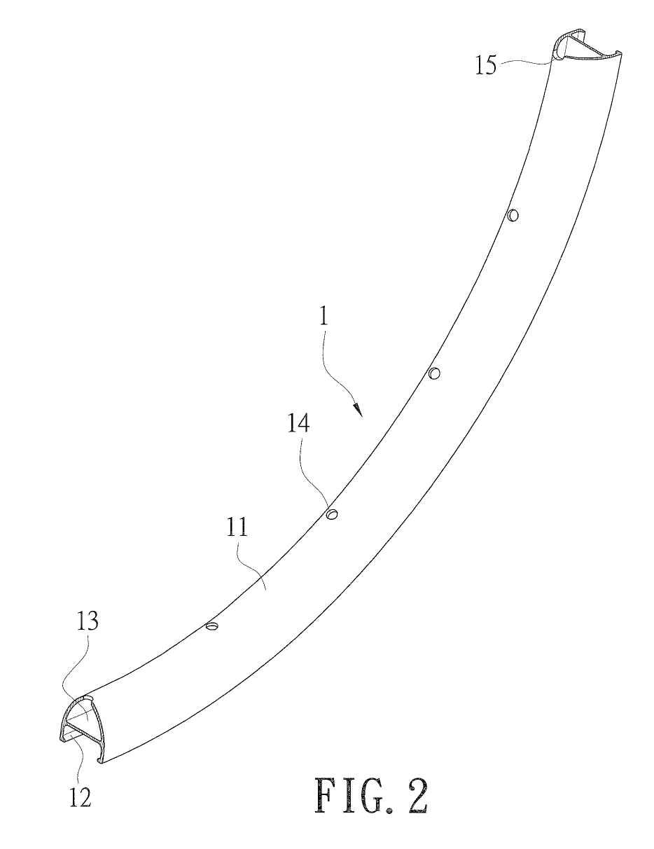

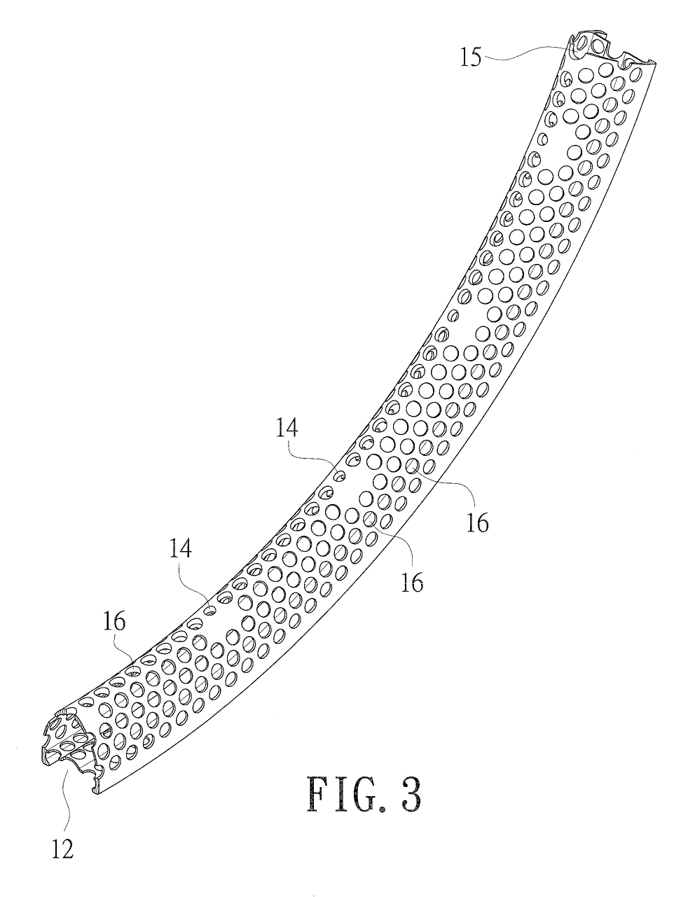

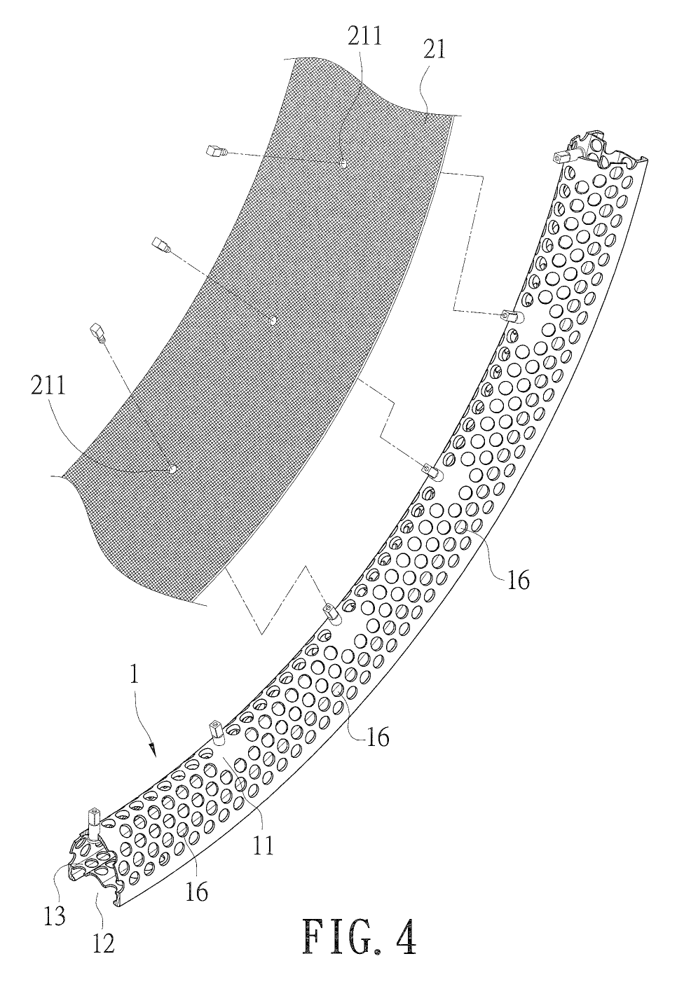

First, the utilized technology and means of this invention are shown in FIGS. 1-6. FIG. 1 is a process follow chart of the lightweight process of bicycle wheels according to this invention. The steps are described below.

S1) A rim frame 1 is provided. The rim frame 1 has an inner frame 11 combined with spokes, a cladding part 12 corresponding to the assembled tire, and a support part 13 between the inner frame 11 and the cladding part 12. Several spoke coupling holes 14 are circularly disposed on the inner frame, and a gas nozzle hole 15 penetrates the inner frame 11.

S2) Through holes are formed by milling. The surfaces of the inner frame 11 and the support part 13 are milled to form plural through holes 16 uniformly distributed on the surfaces of the inner frame 11 and the support part 13. The area occupied by the through holes 16 is 35% to 85% of the total surface of the inner frame 11 and the support part 13. The distance between the adjacent through holes 16 is kept at 0.5-1.5 mm.

S3) The surface roughening is performed. After milling to form the through holes 16, the surface of the rim frame 1 is roughened to increase the surface roughness thereof. In this step, the surface roughness of the rim frame 1 is increased to produce good combination effect with a carbon fiber cloth 21.

S4) The carbon fiber cloth is coated. The carbon fiber cloth 21 is trimmed to a predetermined shape and leave the holes 211 for the spoke coupling holes 14 and the gas nozzle hole 15. Then, the surface of the rim frame 1 and the through holes 16 are covered by the carbon fiber cloth 21. The rim frame 1 is covered by 1-2 layers of the carbon fiber cloth 21, and the striations of the carbon fiber cloth 21 are staggeringly laminated.

S5) Heat setting is performed. The rim frame 1 covered by the carbon fiber cloth 21 is placed in a mold, and then heatset to form a carbon fiber layer 2. S6) Surface treatment is performed. The surface of the rim covered by the carbon fiber layer 2 is treated by polishing and then spraying to form a protection layer. Accordingly, a lightweight rim product of a bicycle is obtained.

As in the embodiment of the lightweight process of the bicycle's wheel in this invention, the rim frame 1 is made from an aluminum alloy or a magnesium alloy. The magnesium alloy is the lightest metal having advantages of high strength and high rigidity, but the magnesium alloy is highly reactive to be easily oxidized and thus cannot be exposed in the air for a long time. The carbon fiber layer 2, from the carbon fiber cloth 21, covering the rim frame made from magnesium alloy can prevent the magnesium alloy from being oxidized to increase the product's durability.

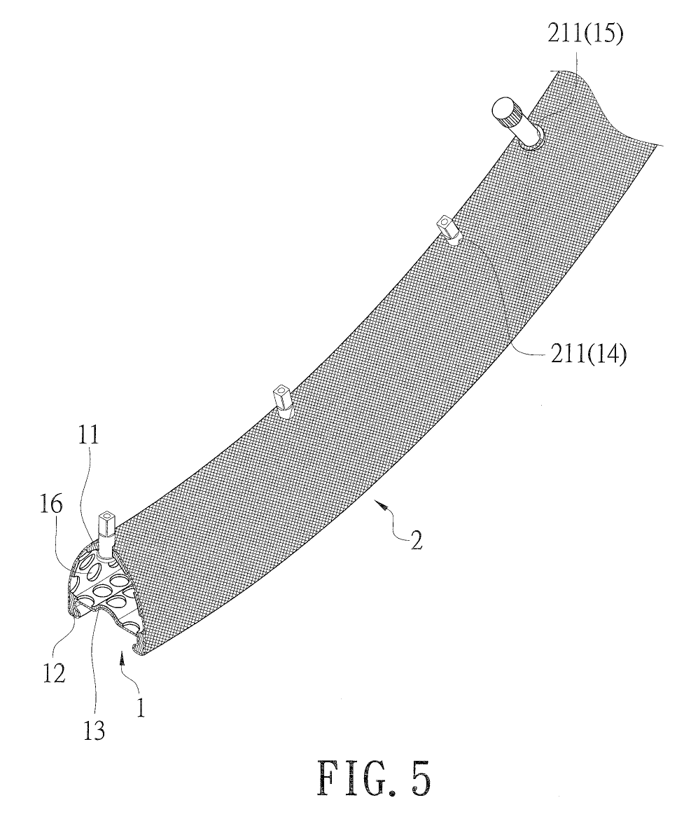

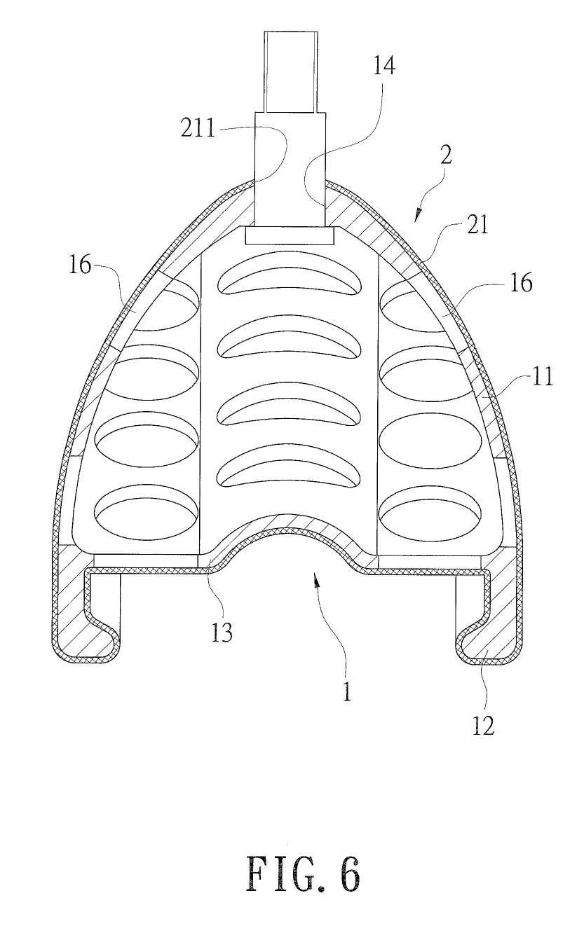

Please refer to FIGS. 5-6. The lightweight rim structure produced by the lightweight process of a bicycle's wheels in this invention comprises the following parts.

The rim frame 1 comprises the inner frame 11 combined with spokes, the cladding part 12 corresponding to the assembled tire, and the support part 13 between the inner frame 11 and the cladding part 12. Several spoke coupling holes 14 are circularly disposed on the inner frame, and a gas nozzle hole 15 penetrates the inner frame 11. The through holes 16 are uniformly distributed on the surfaces of the inner frame 11 and the support part 13. The area occupied by the through holes 16 is 35% to 85% of the total surface of the inner frame 11 and the support part 13. The distance between the adjacent through holes 16 is kept at 0.5-1.5 mm.

The rim frame 1 is covered by 1-2 layers of the carbon fiber cloth 21. The carbon fiber cloth 21 has left the holes 211 for the spoke coupling holes 14 and the gas nozzle hole 15. The carbon fiber cloth 21 covers the through holes 16.

From the illustrations of the element and embodiments above, it can be known that this invention has the following advantages, comparing with the existing structures.

1. In this invention, the through holes are uniformly distributed on the surfaces of the inner frame and the support part. A distance is left between the adjacent through holes for combining with the carbon fiber layer to increase the attaching surface of the carbon fiber layer. Therefore, the carbon fiber layer can be smoothly attached on the rim frame.

2. The weight of the rim frame is decreased most by the though hole milling. Carbon fiber layers covering the rim frame can increase the structural strength of the rim product. Therefore, the carbon fiber rim has advantages of both light weight and strong structure.

3. The light weight rim uses metal to be the rim frame, and then the carbon fiber cloth covers the rim frame. Therefore, the number of the covering carbon fiber layers can be greatly decreased to decrease the usage amount of the carbon fiber cloth and thus the production cost.

4. In this invention, the lightweight rim can greatly decrease the needed number of the carbon fiber cloth layers, and the stable attachment can be also maintained. Therefore, the working hours and the process of the manufacturing can be shortened to speed the manufacturing process and increase the productivity and the yield.

What is claimed is:

1. A lightweight process of bicycle's wheels, comprising:
S1) providing a rim frame comprising an inner frame, a cladding part, and a support part between the inner frame and the coating part, wherein the inner frame comprises several spoke coupling holes disposed circularly and a gas nozzle hole penetrating the inner frame part and the support part;
S2) milling the inner frame and the support part to form plural through holes uniformly distributed thereon, wherein areas occupied by the through holes is 35% to 85% of a total surface of the inner frame and the support part, as io well as a distance between the adjacent through holes is 0.5-1.5 mm;
S3) roughening the surface of the rim frame to increase the roughness thereof;
S4) trimming a carbon fiber cloth to a predetermined shape and then covering the rim frame and the through holes by the trimmed carbon fiber cloth;
S5) heatsetting the rim frame covered by the trimmed carbon fiber cloth in a mold to form a carbon fiber layer; and
S6) treating the surface of the rim frame covered by the carbon fiber layer to obtain a product of a bicycle's lightweight rim.

2. The lightweight process of claim 1, wherein the rim frame is made from an aluminum alloy or a magnesium alloy.

3. The lightweight process of claim 1, wherein the surface treating step (S6) comprises polishing the surface and spraying to form a protective layer thereon.

4. The lightweight process of claim 1, wherein the rim frame is covered by 1-2 layers of the carbon fiber cloth.

5. The lightweight process of claim 4, wherein striations of the carbon fiber cloth are staggeringly laminated.

6. The lightweight process of claim 3, wherein the rim frame is covered by 1-2 layers of the carbon fiber cloth.

7. The lightweight process of claim 6, wherein striations of the carbon fiber cloth are staggeringly laminated.

8. A lightweight structure of a bicycle's rim, comprising:
a rim frame comprises an inner frame combined with spokes, a cladding part corresponding to an assembled tire, and a support part between the inner frame and the cladding part, wherein plural spoke coupling holes are circularly disposed on the inner frame, a gas nozzle hole penetrates the inner frame, and through holes are distributed on the inner frame and the support part, wherein area occupied by the through holes is 35% to 85% of the total surface of the inner frame and the support part, and a distance between the adjacent through holes is kept at 0.5-1.5 mm; and
a carbon fiber layer covering the rim frame made from at least a layer of carbon fiber cloth having holes corresponding to the spoke coupling holes and the gas nozzle hole but covering the through holes.
